(19) United States
(12) Patent Application Publication
(10) Pub. No.: US 2017/0268421 A1
(43) Pub. Date: Sep. 21, 2017

(54) HYDRAULIC VALVE FOR SHIFTING AN ACTUATION PISTON OF A CONNECTING ROD

(71) Applicant: ECO Holding 1 GmbH, Marktheidenfeld (DE)

(72) Inventors: Alexander Mudra, Goerlitz (DE); Dietmar Schulze, Muenzenberg (DE)

(21) Appl. No.: 15/477,339

(22) Filed: Apr. 3, 2017

Related U.S. Application Data
(63) Continuation of application No. PCT/EP2015/078013, filed on Nov. 30, 2015.

(30) Foreign Application Priority Data
Dec. 19, 2014 (DE) DE102014119157.9
Jan. 19, 2015 (DE) DE102015100662.6

(51) Int. Cl. F02B 75/04; F16K 31/122; F16C 7/06

(52) U.S. Cl. CPC F02B 75/045; F16C 7/06; F16K 31/1221

(57) ABSTRACT

A hydraulic valve with a hydraulic fluid, in particular for shifting an actuation piston in a connecting rod for a variable compression internal combustion engine, the hydraulic valve including a valve housing which includes a first operating connection and a second operating connection and a supply connection that is loadable with a hydraulic pressure of the hydraulic fluid so that a piston that is movably arranged in the valve housing is displaceable against a force of a preloaded spring, wherein the piston is optionally arrestable in a first shifting position or in a second shifting position, wherein an axial shaft arranged in the valve housing includes a shifting coulisse, and wherein the piston is movable from the first shifting position into the second shifting position and from the second shifting position into the first shifting position by a control element guided in the shifting coulisse.

### RELATED APPLICATIONS

This application is a continuation of International application PCT/EP 2015 078 013 filed on Nov. 30, 2015 claiming priority from and incorporating by reference German Patent Applications

DE 10 2014 119 157.9 filed on Dec. 19, 2014 and
DE 10 2015 100 662.6 filed on Jan. 19, 2015.

### FIELD OF THE INVENTION

The invention relates to a hydraulic valve with a hydraulic fluid in particular for shifting an actuation piston of a connecting rod for a variable compression of an internal combustion engine of a motor vehicle and a connecting rod with the hydraulic valve.

### BACKGROUND OF THE INVENTION

In internal combustion engines a high compression ratio has a positive impact upon efficiency of the internal combustion engine. Compression ratio typically is a ratio of an entire cylinder volume before compression relative to a remaining cylinder volume after the compression. In internal combustion engines with external ignition, in particular gasoline engines which have a fixed compression ratio, the compression ratio can only be selected up to a level so that a so called knocking of the internal combustion engine is prevented under full load operation. However, the compression ratio can be selected with higher values for much more prevalent partial load operations of the internal combustion engine thus at a lower level of cylinder filling without the “knocking” occurring. The important partial load operations of an internal combustion engine can be improved when the compression ratio is variably adjustable. In order to adjust the compression ratio for example systems with variable connecting rod length are known.

From DE 10 2010 016 037 A1 a switch valve is known, in particular for controlling a hydraulic fluid flow and including a ball pen mechanism wherein the switch valve is alternatively interlockable in a first or in a second interlocking position by imparting an actuation impulse upon an actuation device of the ball pen mechanism. The ball pen mechanism is coupled with the hydraulic valve so that the first interlocking position or the second interlocking position corresponds to a respective first or second shifting position of a control piston of the hydraulic valve.

The hydraulic valve is provided with a ball pen mechanism which alternatively shifts the hydraulic valve from a first shifting position into a second shifting position and vice versa by applying an actuation impulse. In order to shift the hydraulic valve from the first shifting position into the second shifting position by applying the actuation impulse upon the actuation device of the ball pen mechanism the control piston of the hydraulic valve is displaceable against a direction of the actuation impulse by a predetermined distance. This facilitates a shifting of the hydraulic valve from the first shifting position into the second shifting position. In order to shift the hydraulic valve from the second shifting position into the first shifting position by applying the actuation impulse on the actuation device of the ball pen mechanism the control piston of the hydraulic valve is displaceable approximately in a direction of the actuation impulse by a predetermined travel distance. This facilitates shifting the hydraulic valve from the second shifting position to the first shifting position.

### BRIEF SUMMARY OF THE INVENTION

Thus, it is an object of the invention to provide a hydraulic valve for controlling a hydraulic fluid which facilitates safe shifting of the hydraulic valve while providing a robust construction.

Thus, it is another object of the invention to provide a connecting rod with the hydraulic valve which facilitates safe shifting of the hydraulic valve while providing a robust construction.

The first object is achieved according to an aspect of the invention by a hydraulic valve with a hydraulic fluid, in particular for shifting an actuation piston in a connecting rod for a variable compression internal combustion engine, the hydraulic valve including a valve housing which includes a first operating connection and a second operating connection and a supply connection that is loadable with a hydraulic pressure of the hydraulic fluid so that a piston that is movably arranged in the valve housing is displaceable against a force of a preloaded spring, wherein the piston is optionally arrestable in a first shifting position or in a second shifting position, wherein an axial shaft arranged in the valve housing includes a shifting coulisse, and wherein the piston is movable from the first shifting position into the second shifting position and from the second shifting position into the first shifting position by a control element guided in the shifting coulisse.

The second object is achieved by a connecting rod with a hydraulic valve with a hydraulic fluid for shifting an actuation piston in the connecting rod for a variable compression internal combustion engine, the hydraulic valve including a valve housing which includes a first operating connection and a second operating connection and a supply connection that is loadable with a hydraulic pressure of the hydraulic fluid so that a piston that is movably arranged in the valve housing is displaceable against a force of a preloaded spring, wherein the piston is optionally arrestable in a first shifting position or in a second shifting position, wherein an axial shaft arranged in the valve housing includes a shifting coulisse, and wherein the piston is movable from the first shifting position into the second shifting position and from the second shifting position into the first shifting position by a control element guided in the shifting coulisse.

Advantageous embodiments and advantages of the invention can be derived from the dependent claims, the description and the drawing figure.

A hydraulic valve with a hydraulic fluid is proposed, in particular for shifting an actuation piston in a connecting rod for a variable compression of an internal combustion engine. The hydraulic valve includes a valve housing which includes a first operating connection and a second operating connection and a supply connection that is loadable by a hydraulic pressure of the hydraulic fluid so that a piston that is moveably arranged in the valve housing is displaceable against a force of a preloaded spring. Thus, the piston is optionally interlockable in a first shifting position and in a second shifting position. An axial shaft arranged in the valve housing includes a shifting coulisse so that the piston is movable by a control element supported in the coulisse from the first shifting position of the piston into a second shifting position of the piston and from the second shifting position of the piston into the first shifting position of the piston.

According to the invention a hydraulic valve which is arranged in a connecting rod mechanism controls a hydraulic fluid which changes the compression ratio of an internal combustion engine through an actuation piston in the connecting rod mechanism. As a matter of principle there are two different valve concepts which can implement the function. On the one hand side there is a bi-stable hydraulic valve which shifts through different pressure levels of the hydraulic fluid. According to another concept the hydraulic valve is actuated by pressure pulses. According to the concept of pressure pulse shifting it can occur that a hydraulic valve that does not shift when loaded with a pressure pulse generates an asymmetry of the valve positions between plural valves. When using the concept of pressure level shifting problems can occur when there are pressure variations of the hydraulic fluid since this can lead to an undesired shifting of the hydraulic valve. Additional problems are a pronounced dependency of the shifting properties from the speed of the internal combustion engine.

These problems can be overcome with the proposed solution through a mutual supplementation of the advantages of both concepts with a hydraulic valve which includes at least two stable shifting conditions. A piston is arranged in the valve housing which piston is subjected to an axial force through the applied hydraulic pressure of the hydraulic fluid. This axial force is counteracted by a control element which is supported at a preloaded spring. The position of the control element is fixated by a support pin in a guide track of a shifting coulisse. The piston is arranged in a first shifting condition as a starting position in an interlocked position. A first operating connection is opened towards the supply connection and the second operating connection is closed. The hydraulic pressure is at a normal level. When the hydraulic pressure increases to a predetermined value the piston moves together with the control element along a track that is predetermined by the shifting coulisse to a first stop and remains in this position as long as the hydraulic pressure is maintained. As soon as the hydraulic pressure drops again the support pin can interlock in a second interlocking position of the shifting coulisse and the piston is arranged in a second shifting condition. The second operating connection is open to the supply connection at the first stop and also in the second interlocking position and the first operating connection is closed. The support pin of the control element can thus always only move in a predetermined direction along the guide path of the shifting coulisse since it is supported by support ramps and shoulders.

When another hydraulic burst is applied the support pin moves to the second stop of the shifting coulisse. Only when the hydraulic pressure drops again the control element moves back into the first interlocking position while being supported at the support pin and the first operating connection is opened to the supply connection again.

Thus, it is an advantage of the hydraulic valve according to the invention that it implements a fail-safe concept. Namely when one hydraulic valve shifts incorrectly in an arrangement with plural hydraulic valves, all hydraulic valves can be brought into the first interlocking position through a pressure ramp. Thus, the hydraulic pressure is increased to a predetermined value and lowered again thereafter. This has the consequence that all involved hydraulic valves of the arrangement are in the first interlocking position. This behavior is implemented by an asymmetrical configuration of the guide track of the shifting coulisse. Therefore the two stops are axially offset by a predetermined amount so that a higher hydraulic pressure is required for reaching the first stop which hydraulic pressure is higher by a predetermined value than the hydraulic pressure required for reaching the second stop of the shifting coulisse.

Thus an advantage of the invention is a simple configuration of the hydraulic valve with low component cost. Furthermore the hydraulic valve has a long service life since the shift actuation is controlled by the control element with the guide pin in the shift coulisse and only these components have to be fabricated from accordingly loadable materials. The hydraulic valve itself has a low amount of wear since the piston has large contact surfaces.

The shifting device is easily mountable and operates safely when the craft shaft rotates. The individual required components are producible in a cost effective manner. The shifting device is not dependent from a particular speed of the internal combustion engine, Shifting conditions are selectable at will. Operating the internal combustion engine with cylinders switched off is possible.

According to an advantageously embodiment the first switching position and the second switching position can be configured as positions of the piston that are stable in a pressure range. Thus, the hydraulic valve is actuatable as a bistable shift valve configured as a ball pen. The piston thus remains as a shift element in one of the two shifting positions independently from the hydraulic pressure and can then only be released from one of the shifting positions by a pressure pulse or a pressure ramp and respectively moved into the other shifting position.

Thus, according to an advantageous embodiment the first operating connection can be open towards the supply connection in the first shifting position and the second operating connection can be closed towards the supply connection and in the second shifting position the second operating connection can be open to the supply connection and the first operating connection can be closed to the supply connection. This way it is assured that only one respective operating connection is open and no intermediary condition of an element shifted by the hydraulic valve, e.g. a control piston of a connecting rod for a variable compression can occur.

According to an advantageous embodiment the piston can be interlockable in the first shifting position in a first interlocking position of the shifting coulisse and in the second shifting position in a second interlocking position of the shifting coulisse. Interlocking the piston assures that fluctuations in the hydraulic pressure to not impact an operating position of the piston and thus it's shifting properties e.g. of an actuation piston. This provides safe operations of the hydraulic valve.

According to an advantageous embodiment the control element can be supportable in the shifting coulisse by an elastically supported guide pin. It is advantageous when the guide pin is elastically supported since it can then follow the guide path of the shifting coulisse easily. Thus, a change of a height of the guide path can be easily implemented by guide ramps and shoulders. This assures safe function of the control element of the hydraulic valve since the guide pin can thus easily follow different elevations. Advantageously an elastic support of the guide pin can be easily implemented by an elastic spring, e.g. a leaf spring.

According to an advantageous embodiment the shift coulisse can include at least one guide ramp with a shoulder so that the control element is only movable in a predetermined direction. Since the guide pin of the control element follows the guide track of the shift coulisse and is pressed onto the guide track in particular by a spring it is assured that the guide pin can also follow a guide ramp which can then transition into a shoulder after reaching a predetermined height. The guide pin will follow the guide ramp and the shoulder. Thereafter the guide pin cannot be run backward anymore because the shoulder is too steep and cannot be overcome. Thus, it is assured that the control element with the guide pin and thus also the piston connected with the control element can follow the guide track of the shifting coulisse only in one direction.

According to an advantageous embodiment the control element can be supported at the preloaded spring and can be movable against the spring wherein the control element is arranged in operative connection with the piston. The piston is supported this way also at the spring so that the piston that is loaded with the hydraulic pressure is in an overall force equilibrium with the spring. Thus, the hydraulic fluid that impacts the piston on one side facilitates adjusting the position of the piston with the hydraulic pressure in that the piston moves axially in one direction depending on the spring force or the hydraulic pressure prevailing.

According to an advantageous embodiment the control element can be guidable from the first interlocking position through a first stop of the shifting coulisse to the second interlocking position and through a second stop of the shifting coulisse back to the first interlocking position. This configuration of the shifting coulisse with support ramps and shoulders facilitates that the control element and thus the piston associated therewith are only movable in a predetermined running direction of the shifting coulisse. Thus, fail safe operations of the hydraulic valve are obtained since a fallback position, for example a first interlocking position, can always be reached through a predetermined value of the hydraulic pressure.

According to an advantageous embodiment the piston can be disengageable by a pressure increase of the hydraulic fluid from one of the two switching positions. Through a pressure increase a next stop in the guide path of the shifting coulisse can be reached by the control element through a guide ramp of the shifting coulisse and thus with a further drop of the hydraulic pressure the next shifting position can be reached.

According to an advantageous embodiment the piston can be returnable into the first switching position through a pressure ramp of the hydraulic fluid. Thus, fail-safe properties of the hydraulic valve become implementable since this way an arrangement of hydraulic valves can be returned into a starting position in a safe manner. This facilitates that a control element is disengageable through a pressure increase from an interlocking position and the guide track of the shifting coulisse allows only one movement direction so that the first shifting position is reachable again in any case.

According to another aspect the invention relates to a connecting rod with a hydraulic valve with a hydraulic fluid, in particular for shifting an actuation piston in the connecting rod for a variable compression of an internal combustion engine, the hydraulic valve including a valve housing which includes a first operating connection and a second operating connection and a supply connection that is loadable with a hydraulic pressure of the hydraulic fluid, wherein a piston that is movably arranged in the valve housing is movable against a force of a preloaded spring. Thus, the piston is optionally arrestable in a first shifting position and in a second shifting position. Furthermore an axial shaft arranged in the valve housing includes a shifting coulisse, so that the piston is movable by a control element that is guided in the shifting coulisse from the first shifting position into the second shifting position and form the second shifting position into the first shifting position. The hydraulic valve in this embodiment can actuate an actuation piston arranged in the connecting rod for a variable compression of the internal combustion engine so that based on the bi-stable embodiment of the hydraulic valve with two switching positions a safe control of the connecting rod is obtained. This provides overall for a safe operation of the function of the variable compression of the internal combustion engine since the risk of erroneous shifting of the hydraulic valve is reduced for an arrangement of plural hydraulic valves. When an erroneous shifting occurs all hydraulic valves can be moved back into a starting position.

### BRIEF DESCRIPTION OF THE DRAWINGS

Further advantages of the invention can be derived from the subsequent drawing description. In the drawing figures embodiments of the invention are illustrated. The drawings, the description and the claims include plural features in combination. A person skilled in the art will advantageously review the features individually and combine them into useful additional combinations, wherein:

FIG. 1 illustrates a sectional view at several levels of the hydraulic valve according to an embodiment of the invention;

FIG. 2 illustrates a top view of a shifting coulisse according to an embodiment of the invention;

FIG. 3 illustrates an isometric view of the shifting coulisse according to an embodiment of the invention;

FIG. 4 illustrates an additional isometric view of the shifting coulisse according to an embodiment of the invention;

FIG. 5 illustrates another isometric view of the shifting coulisse according to an embodiment of the invention;

FIG. 6 illustrates a cross sectional view of the hydraulic valve according to an embodiment of the invention in a first switching condition;

FIG. 7 illustrates a cross sectional view of the hydraulic valve according to an embodiment of the invention in a second shifting condition; and

FIG. 8 illustrates a cross sectional view of a connecting rod with a hydraulic valve according to an embodiment of the invention.

### DETAILED DESCRIPTION OF THE INVENTION

In the figures identical or like components are labeled with identical reference numerals. The drawing figures only illustrate embodiments and do not limit the scope and spirit of the invention.

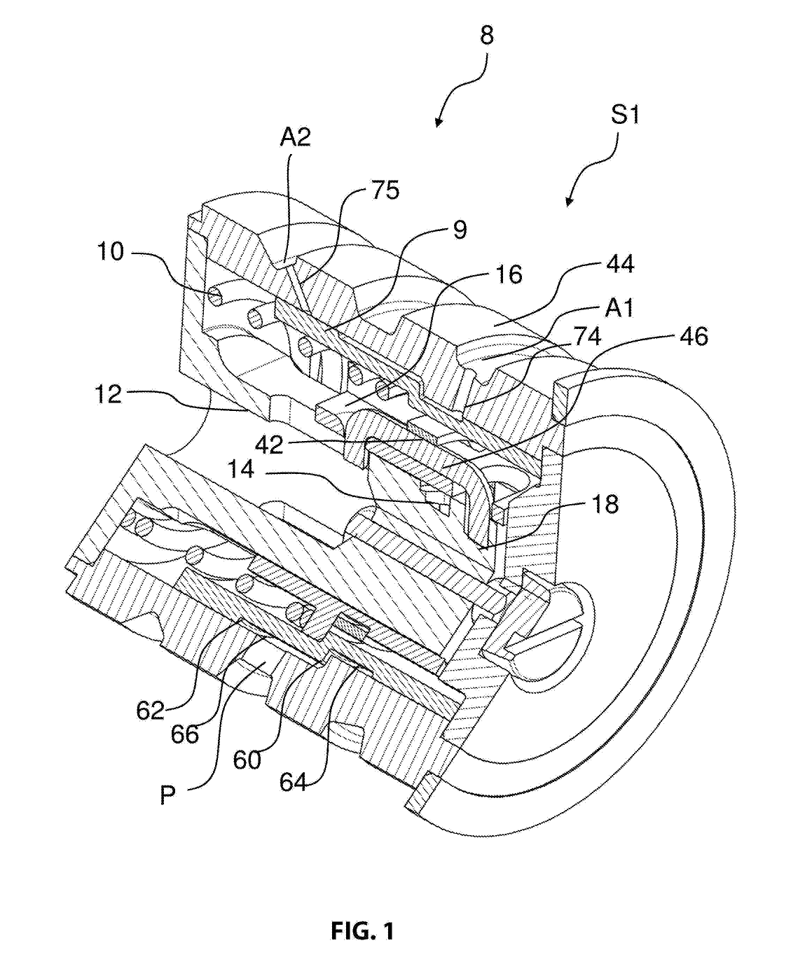

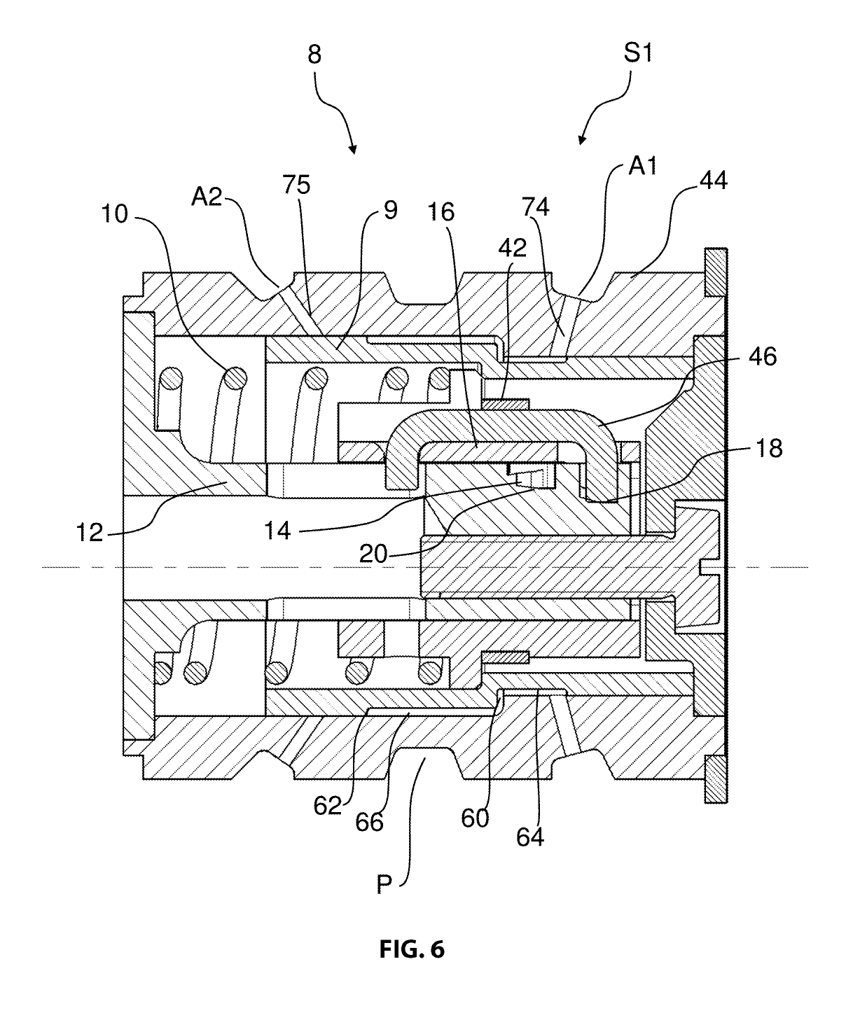

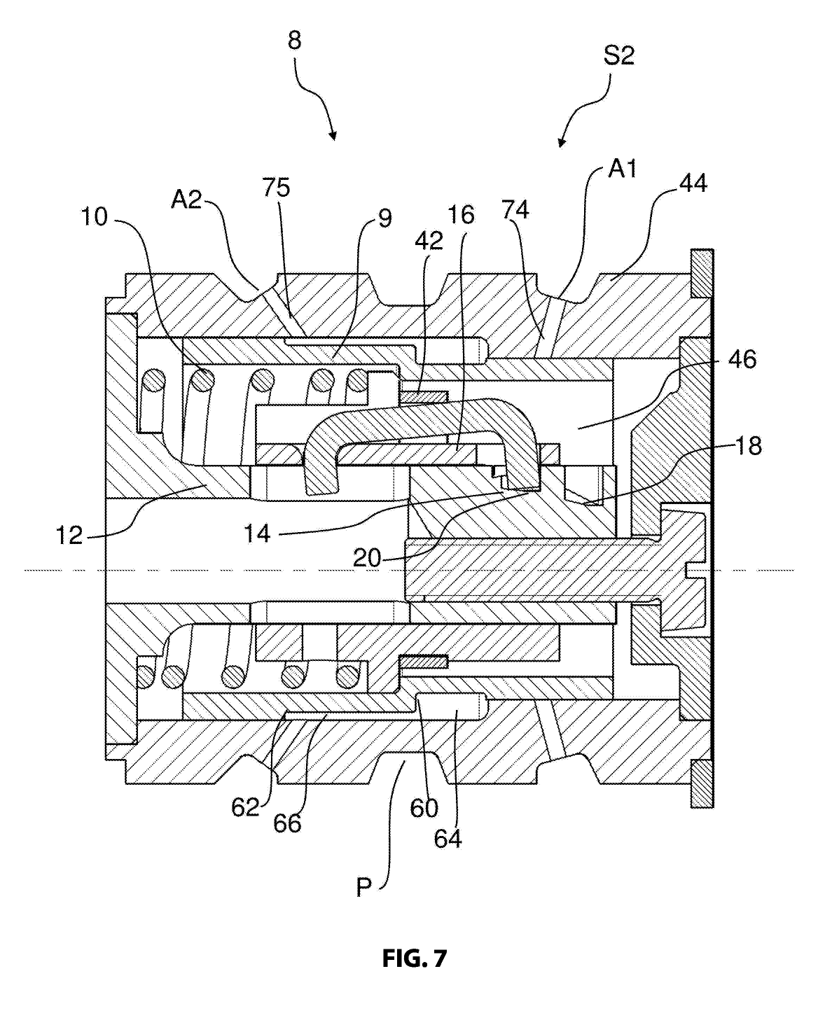

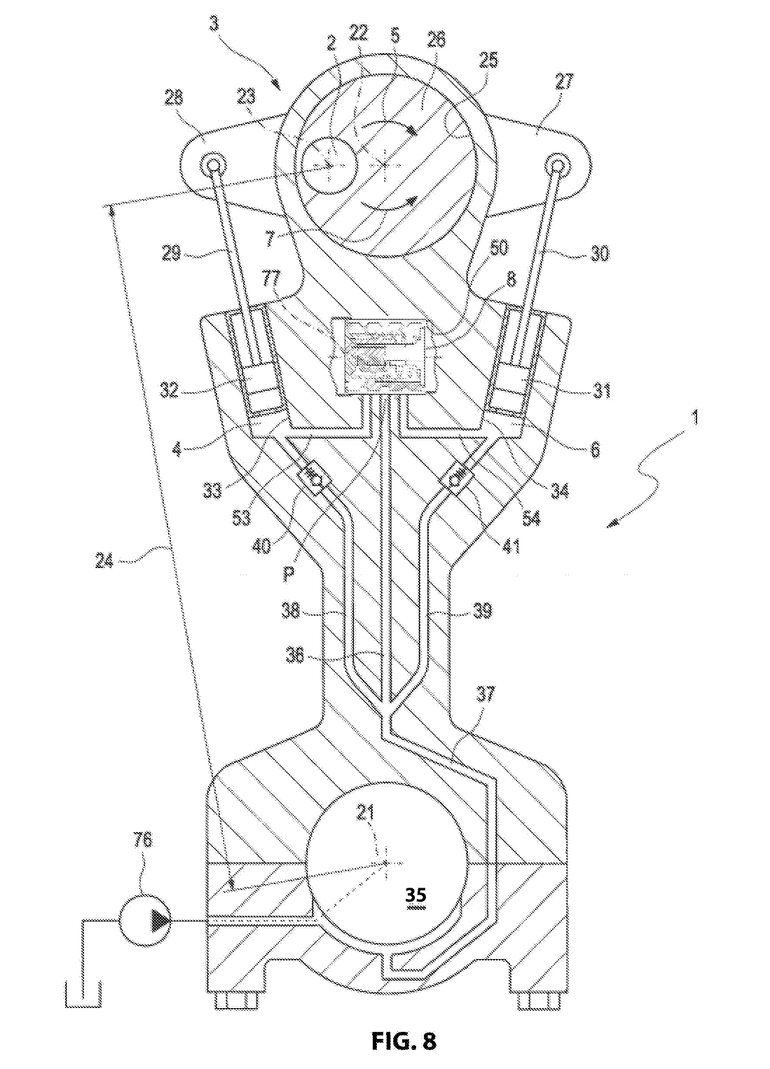

FIG. 1 illustrates a sectional view of the hydraulic valve 8 in plural levels according to an embodiment of the invention. The hydraulic valve 8 with a hydraulic fluid in particular for shifting an actuation piston 31, 32 in a connecting rod 1 for a variable compression internal combustion engine (illustrated in FIG. 8) includes a valve housing 44 which includes a first operating connection A1 and a second operating connection A2 and a supply connection P that that is loaded with the hydraulic pressure of the hydraulic fluid. Thus, a piston 9 that is movably arranged in the valve housing 44 and configured as a shoulder piston is movable against a force of a preloaded spring 10. The spring 10 which is supported at one end of the at a shaft 12 that is bolted together with the valve housing 44 is supported at another end at a control element 16 which is in turn operatively connected with the piston 9. The piston 9 is optionally arrestable in a first shifting position S1 and in a second shifting position S2, wherein the axial shaft 12 arranged in the valve housing 44 includes a shifting coulisse 14 and the piston 9 is movable by a control element 16 guided in the shifting coulisse 14 so that the piston is movable from the first shifting position S1 into the second shifting position S2 and from the second shifting position S2 into the first shifting position S1. The shifting positions S1 and S2 are illustrated in more detail in the cross sections in FIGS. 6 and 7. The first shifting position S1 and the second shifting position S2 are respectively configured as positions of the hydraulic valve that are stable in a pressure range. In the first shifting position S1 the first operating connection A1 is open towards the supply connection P and the second operating connection A2 is closed towards the supply connection P and in the second shifting position S2 the second operating connection A2 is open towards the supply connection P and the first operating connection A1 is closed towards the supply connection P. Alternatively it is conceivable to connect the two operating connections A1, A2 with a tank connection or a crank case and to open or close them as a function of the shifting position towards the tank connection or the crank case.

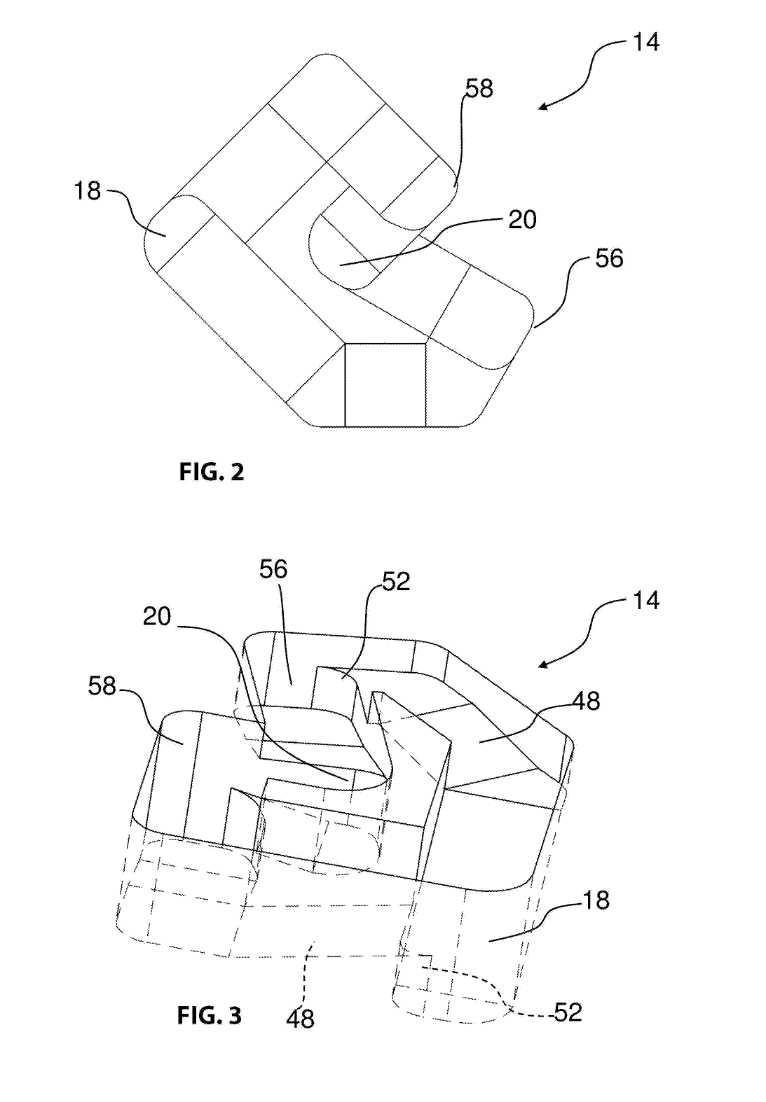

The piston 9 is interlockable in the first shifting position S1 in a first interlocking position 18 of the shifting coulisse 14 and in a second shifting position S2 in a second interlocking position 20 (illustrated in FIG. 2). The control element 16 is movable in the shifting coulisse 14 by a support pin 46 that is elastically supported in the leaf spring 42.

The piston 9 is disengageable from one of the two switching positions S1, S2 through a pressure increase of the hydraulic fluid and returnable into the first shifting position S1 by a pressure ramp of the hydraulic fluid.

The piston 9 is loadable with hydraulic pressure through the supply connection P so that a first piston surface 60 is loaded with hydraulic pressure through a first ring groove 64 and a second piston surface 62 of the piston 9 is loaded with the hydraulic pressure through a second ring groove 66. Upon pressure increase the piston 9 can thus be moved against the spring 10. In the illustrated shifting position S1 the operating connection A1 is open through the first bore hole 74, the first ring groove 64 of the piston 9, the first piston surface 60 and the second ring groove 66 to the supply connection P. Thus, the hydraulic fluid can switch an actuation piston 30, 31 of a connecting rod through the operating connection A1. The piston 9 is interlocked in the shifting position S1 through the control element 16 and the guide pin 46 in the first interlocking position 18.

In a second shifting position S2 the piston 9 is pressed by the hydraulic fluid from the supply connection P through the hydraulic pressure on the first and the second piston surface 60, 62 against the spring 10. The spring 10 is thus pushed together and the piston 9 moves axially in a direction of the spring 10. When reaching the second bore hole 75 with the second piston surface 62 the operating connection A2 is opened through the second bore hole 75 and the second ring groove 66 towards the supply connection P.

FIG. 2 illustrates a top view of a shifting coulisse 14 according to an embodiment of the invention. The shifting coulisse 14 is arranged as a recess in the shaft 12 and represents a running surface providing the guide path for the support pin 46 of the control element 16. The shifting coulisse 14 includes a first interlocking position 18 as a base position and first shifting position S1 of the piston 9. From there the support pin 46 can move with increasing hydraulic pressure to a first stop 56 and can interlock in the second interlocking position 20 as a second shifting position S2 of the piston 9 when the hydraulic pressure drops again. From this second interlocking position 20 the support pin 46 can be disengaged again when the hydraulic pressure increases and can move to the second stop 58. The support pin 46 cannot move back to the first stop 56 since it would have to overcome a shoulder 52. When the hydraulic pressure drops again the support pin 46 can move out of the second stop 58 back to the first interlocking position 18 and can interlock there.

FIG. 3 illustrates an isometric view of the shifting coulisse 14 according to an embodiment of the invention. The shifting coulisse 14 includes plural guide ramps 48 with a shoulder 52 so that the control element 16 is only movable in a predetermined direction. The support ramps 48 are respectively arranged at least between the first and the second interlocking position 18, 20 and include a shoulder 52 at an end in front of a stop 56, 68 and an interlocking position 18, 20 so that the support pin 46 can only move forward in one direction and not backward. Thus, the control element 16 is forced to move from the first interlocking position 18 over a first stop 56 of the shifting coulisse 14 to the second interlocking position 20 and over a second stop 58 of the shifting coulisse 14 back to the first interlocking position 18.

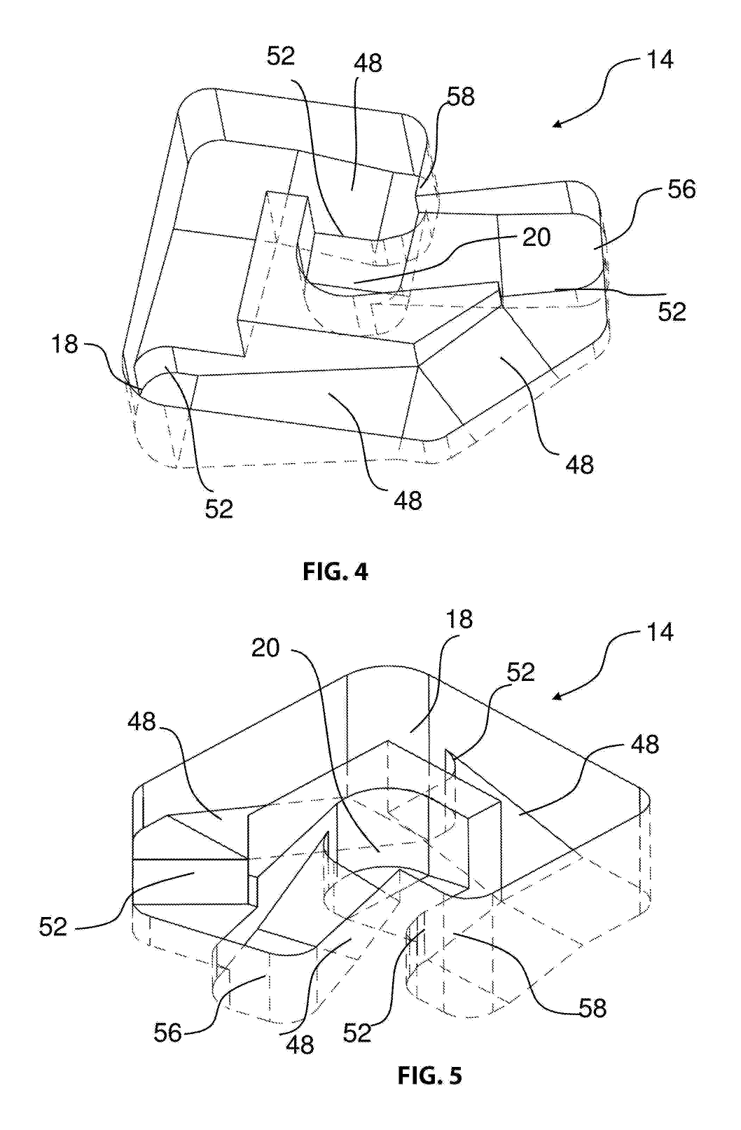

FIGS. 4 and 5 illustrate additional isometric views of the shifting coulisse 14 according to an embodiment of the invention to further illustrate the arrangement of the stops 56, 58 of the interlocking positions 18, 20 and of the support ramps 48 and the shoulders 52. A support ramp 48 is respectively arranged between the first interlocking position 18 and the first stop 56, between the first stop 56 and the second interlocking position 20, between the second interlocking position 20 and the second stop 58 and between the second stop 58 and the first interlocking position 18. The support ramps 48 respectively terminate with a shoulder 52 so that the running surface of the shifting coulisse 14 is configured as a saw tooth.

FIG. 6 illustrates a cross section of the hydraulic valve 8 according to an embodiment of the invention in a first shifting position S1. In the illustrated shifting position S1 the operating connection A1 is opened through the first bore hole 74, the first ring groove 64 of the piston 9, the first piston surface 60 and the second ring groove 66 towards the supply connection P. Thus, the hydraulic fluid can shift an actuation piston 30, 31 of the connecting rod 1 through the operating connection A1. The piston 9 is interlocked in the shifting position S1 through the control element 16 and the support pin 56 in the first interlocking position 18. The piston 9 can be loaded with hydraulic fluid through the supply connection P which is configured as a ring groove in the valve housing 44 so that a first piston surface 60 is loaded with hydraulic pressure through a first ring groove 64 and a second piston surface 62 of the piston 9 is loaded with the hydraulic pressure through a second ring groove 66. Upon increasing pressure the piston 9 can be moved against the spring 10 and transferred into a second shifting position S2.

Thus, FIG. 7 illustrates a cross section of the hydraulic valve 8 according to an embodiment of the invention in the second shifting condition S2. In the second shifting condition S2 the piston 9 is loaded with the hydraulic pressure through the supply connection P, so that the piston 9 is pressed in operating connection with the control element 16 against the spring 10 through the hydraulic pressure on the first and second piston surface 60, 62. Thus, the spring 10 is compressed and the piston 9 moves axially in a direction towards the spring 10. When reaching the second bore hole 75 with the second piston surface 62 the operating connection A2 is opened through the second bore hole 75 and the second ring groove 66 towards the supply connection P. Thus, the hydraulic fluid can shift an actuation piston 30, 31 of a connecting rod 1 through the operating connection A2. The piston 9 is interlocked in the shifting position S2 through the control element 16 and the support pin 46 in the second interlocking position 20.

FIG. 8 illustrates a cross section through a connecting rod 1 with a hydraulic valve 8 according to an embodiment of the invention. The connecting rod 1 includes the hydraulic valve 8 with the hydraulic fluid, in particular for shifting an actuation piston 31, 32 in the connecting rod 1 for a variable compression of an internal combustion engine. The hydraulic valve 8 includes a valve housing 44 which includes a first operating connection A1 and a second operating connection A2 and a supply connection P that is loaded with a hydraulic pressure of the hydraulic fluid so that a piston 9 that is movably arranged in the valve housing 44 is moved against a force of a preloaded spring. The piston 9 is optionally arrestable in a first shifting position S2 and in a second shifting position S2. An axial shaft 12 arranged in the valve housing 44 includes a shifting coulisse 14 so that the piston 9 is movable through a control element 16 supported in the shifting coulisse 14 from a first shifting position S1 into a second shifting position S2 and from the second shifting position S2 into the first shifting position S1.

The connecting rod 1 in FIG. 8 includes an upper wrist pin bearing eye 2 in which a wrist pin is inserted that is not shown in more detail. The wrist pin is inserted into the piston of the internal combustion engine in a typical manner with a press fit. The wrist pin eye 2 is pivotable by an eccentrical element 3 about a pivot axis 22 which is offset and parallel to the longitudinal axis 23 of the wrist pin eye 2. Thus, it is possible to adjust a distance 24 of the wrist pine eye 2 from a connecting rod journal axis of a connecting rod journal 35. Thus, a variable compression of the combustion chamber can be implemented.

The eccentrical element 3 includes a pinion 26 that is pivotably arranged in a bore hole 25 of the connecting rod 1. Two arms 27, 28 extend diametrically relative to each other from the pinion 26. At ends of the two arms 27, 28 support rods 29, 30 are attached. The support rods 29, 30 are pivotably connected with two small linear pistons 31, 32. Thus, it is possible to pivot the pinion 26 within the bore hole 25 of the connecting rod 1. Thus, the small linear piston 31, 32 deploys from a cylindrical bore hole 34 or 33 within the connecting rod 1 while the other linear piston 32 or 31 moves into a cylindrical bore hole 33 or 34 of the connecting rod 1. When the left linear piston 32 in the drawing retracts the pinion 26 is pivoted in the rotation direction 7 counter clock wise. However, when the right linear piston 31 in the drawing retracts, the pinion 26 is pivoted in the rotation direction 5 clockwise. The clockwise rotation causes a displacement of the wrist pin eye 2 further upward or away from the connecting rod journal axis 21. Thus, the distance 24 is increased and thus the compression in the combustion chamber increased. For a right linear piston 31 that is retracted to a maximum the combustion chamber is set for maximum compression. In analogy thereto pivoting the pinion 26 counter clockwise, this means in the rotation direction 7, causes a reduction of the compression down to minimum compression.

In order to control the two stages of compression a hydraulic valve 8 with a longitudinal valve axis 77 is provided. The hydraulic valve 8 is inserted into a bore hole 50 in the connecting rod 1. The hydraulic valve 8 facilitates running pressurized hydraulic fluid, for example oil of an internal combustion engine from a displacement chamber 4 or 6 to a supply connection P of the hydraulic valve 8. From the supply connection P the hydraulic fluid is run through a channel 36, 37 to the crank journal 35 where it is introduced into an oil supply of an eccentrical pinion of the crank shaft that is not illustrated in more detail. This eccentrical pinion is rotatably arranged in the connecting rod journal 35 in a typical manner. For example in a four cylinder engine four eccentrical pinions of this type are arranged at the crank shaft. Accordingly four connecting rods 1 with a total of four connecting rod bearing 35 are provided at a four cylinder engine of this type.

The oil supply within the connecting rod bearing 35 comes from the oil pump 76 of the internal combustion engine and supplies the two displacement cavities 4, 6 through feed conduits 38, 39. Thus, a respective check valve 40, 41 is inserted in both feed conduits 38, 39 wherein the check valve closes in a flow direction from the respective displacement cavity 4 or 6 to the oil supply and opens in an opposite flow direction.

Forces transferred from the combustion chamber piston through the wrist pin bearing eye 2 onto the support rods 29, 30 are very high. These high forces are by a large extent greater than the forces which come to bear at the linear piston 31 or 32 due to the pressure of the oil pump 76. Thus, the hydraulic valve 8 can transfer pressure from the first displacement chamber 6 or the second displacement chamber 4 back to the oil supply as a function of the hydraulic valve. When a displacement chamber 6 or 4 is reduced in size due to the high forces of the combustion chamber piston the other displacement chamber 4 or 6 sucks in oil through its opening check valve 40 or 41 from the oil supply. On the path from the oil pump 76 to the oil supply within the crank shaft additional consumers are connected which draw oil. In particular lubricated bearings reduce the oil pressure. The viscosity of the oil is also important for the oil pressure.

What is claimed is:

1. A hydraulic valve with a hydraulic fluid for shifting an actuation piston in a connecting rod for a variable compression internal combustion engine, the hydraulic valve comprising:
a valve housing which includes a first operating connection and a second operating connection and a supply connection that is loadable with a hydraulic pressure of the hydraulic fluid so that a piston that is movably arranged in the valve housing is displaceable against a force of a preloaded spring,
wherein the piston is arrestable in a first shifting position or in a second shifting position,
wherein an axial shaft that is arranged in the valve housing includes a shifting coulisse, and
wherein the piston is displaceable from the first shifting position into the second shifting position and from the second shifting position into the first shifting position by a control element guided in the shifting coulisse.

2. The hydraulic valve according to claim 1, wherein the first shifting position and the second shifting position are respectively configured as positions of the piston that are stable in a pressure range of the hydraulic fluid.

3. The hydraulic valve according to claim 1,
wherein the first operating connection is open towards the supply connection in the first shifting position and the second operating connection is closed towards the supply connection in the first shifting position, and
wherein the second operating connection is open towards the supply connection in the second shifting position and the first operating connection is closed towards the supply connection in the second shifting position.

4. The hydraulic valve according to claim 1,
wherein the first operating connection is open towards a tank connection or a crank case in the first shifting position and the second operating connection is closed towards the tank connection or the crank case in the first shifting position, and
wherein the second operating connection is open towards the tank connection or the crank case in the second shifting position and the first operating connection is closed towards the tank connection or the crank case in the second shifting position.

5. The hydraulic valve according to claim 1,
wherein the piston is interlockable in the first shifting position in a first interlocking position of the shifting coulisse, and
wherein the piston is interlockable in the second shifting position in a second interlocking position of the shifting coulisse.

6. The hydraulic valve according to according to claim 1, wherein the control element is supportable in the shifting coulisse by an elastically supported support pin.

7. The hydraulic valve according to claim 1, wherein the shifting coulisse includes at least one support ramp with a shoulder so that the control element is only movable in one predetermined direction.

8. The hydraulic valve according to claim 1,
wherein the control element is supported at the preloaded spring and movable against the preloaded spring, and
wherein the control element is arranged in operative connection with the piston.

9. The hydraulic valve according to claim 1, wherein the control element is movable from the first interlocking position over a first stop of the shifting coulisse to the second interlocking position and over a second stop of the shifting coulisse back to the first interlocking position.

10. The hydraulic valve according to claim 1, wherein the piston is disengageable by a pressure increase of the hydraulic fluid from the first shifting position or the second shifting position.

11. The hydraulic valve according to claim 1, wherein the piston is reversible into the first shifting position through a pressure ramp of the hydraulic fluid.

12. A connecting rod with a hydraulic valve with a hydraulic fluid for shifting an actuation piston in the connecting rod for a variable compression internal combustion engine, the hydraulic valve comprising:
a valve housing which includes a first operating connection and a second operating connection and a supply connection that is loadable with a hydraulic pressure of the hydraulic fluid so that a piston that is movably arranged in the valve housing is displaceable against a force of a preloaded spring,
wherein the piston is optionally arrestable in a first shifting position or in a second shifting position,
wherein an axial shaft arranged in the valve housing includes a shifting coulisse, and
wherein the piston is movable from the first shifting position into the second shifting position and from the second shifting position into the first shifting position by a control element guided in the shifting coulisse.
